(19) United States
(12) Patent Application Publication
(10) Pub. No.: US 2023/0150302 A1
(43) Pub. Date: May 18, 2023

(54) VEHICLE WHEEL RIM ASSEMBLY

(71) Applicant: Raphael Schlanger, Wilton, CT (US)

(72) Inventor: Raphael Schlanger, Wilton, CT (US)

(21) Appl. No.: 18/100,017

(22) Filed: Jan. 23, 2023

Related U.S. Application Data
(63) Continuation-in-part of application No. 16/988,666, filed on Aug. 9, 2020.
(60) Provisional application No. 62/884,684, filed on Aug. 9, 2019.

(51) Int. Cl. B60B 21/06; B60B 21/02

(52) U.S. Cl. CPC B60B 21/062; B60B 21/025

(57) ABSTRACT

A rim for a vehicle wheel, including a spoke bed wall having: a radially outboard surface; a radially inboard surface; and a spoke hole extending between the outboard surface and inboard surface and configured to receive a spoke of the vehicle wheel; an insert having: a radially outward surface; a radially inward surface; and an opening extending between the outward and inward surfaces and configured to receive the spoke; an adhesive to provide an adhesive joinder between the insert and the outboard surface. The insert opening has a radially outboard first entrance with a first perimeter edge. The insert opening laterally overlaps the spoke hole. At least one of the first perimeter edge, the outward surface, and the insert opening is configured to provide a bearing surface to brace the spoke.

### CROSS-REFERENCE TO RELATED APPLICATIONS

This application is a Continuation-In-Part of U.S. patent application Ser. No. 16/988,666 filed Aug. 9, 2020 and currently pending;

U.S. Patent application Ser. No. 16/988,666 claims priority of Provisional Patent Application Ser. No. 62/884,684, filed Aug. 9, 2019.

### BACKGROUND OF THE INVENTION

### (1) Field of the Invention

The present invention relates to spoked vehicle wheels and bicycle wheels in particular. More specifically, this invention relates to an insert utilized to provide a high strength connection between a spoke and rim of a vehicle wheel.

### (2) Description of the Related Art

In the development of a tension-spoked wheel, the geometry of interaction between the spoke and the rim is of particular importance as it relates to the strength, stiffness, and longevity of the completed wheel structure. The overlie engagement between the under-head surface of the nipple and the spoke bed of the rim serves to provide the requisite bracing to resist the spoke tension forces of the wheel.

Heretofore, most rims do not commonly include reinforcement of the spoke hole to support spoke tensile loads. In the case where such rim reinforcement is desired, this is most commonly achieved with an eyelet secured to the spoke hole. Such an eyelet is described in U.S. Pat. No. 5,651,591, which shows a common “double eyelet” reinforcement that includes a cup portion that extends between the spoke bed and tire bed, and an eyelet surrounding the spoke hole and securing the cup portion to the spoke bed. The double eyelet is an example of a rim reinforcement that is mechanically connected to the rim by the flaring of the eyelet. This arrangement is generally heavy and time-consuming to install, adding weight and cost to the rim. Further, the contour of the cup and eyelet are not well-matched to the outboard surface of the spoke bed, resulting in poor reinforcement of the spoke bed.

Another prior art example of rim reinforcement would be a simple washer that is fitted between the spoke nipple and the spoke bed. The washer is not retained to the rim, making the installation clumsy and tedious. Further, the washer is not well matched to either the outboard surface or the nipple, resulting in poor reinforcement of the spoke bed.

Another prior art example is described in U.S. Pat. No. 7,090,307 where an insert is affixed to the exposed inboard surface of the rim at a brazed or soldered interface. Since the insert is secured to the inboard surface and the spoke is threadably connected to the insert, the spoke tensile loads serve to apply very large tensile load to the insert and the soldered interface. The spoke tensile load effectively works against this interface to strip the insert from the rim. This requires a very large surface area of interface and a large insert, which adds weight to the assembly. Further, this arrangement requires an interface that has very high strength, which adds to the manufacturing cost. This high stress reduces the reliability of the joinder, increasing the propensity for failure during use. The complexity of the insert further adds to the manufacturing cost. Still further, the insert does not truly reinforce the rim, since the spoke tensile load tries to pull the insert away from the rim. Finally, the insert does not provide any self-aligning between the spoke and the rim, which may add to the stress in the spoke, resulting in premature failure of the wheel.

### SUMMARY OF THE INVENTION

The present invention includes vehicle wheel rim having a spoke bed wall with openings therein to receive the mating spokes. The spoke bed wall includes a radially outboard surface and a radial inboard surface with a spoke bed thickness therebetween and a rim opening therethrough, such as a spoke hole. The rim includes a reinforcement insert adhered to the radially outboard surface and/or the sidewalls of the spoke hole. The insert has an insert opening therein that overlaps the rim opening such the resulting combined opening therethrough is configured to receive a spoke, where the spoke includes a bearing surface to brace and bear against the insert and the insert is bearing and bracing against the spoke bed.

The insert is adhered to the spoke bed by means of an adhesive joinder therebetween. The adhesive may be nonmetallic, such as an epoxy or acrylic adhesive, or may be metallic, such as solder or brazing filler. The adhesive may be applied as a liquid, a paste, a supported tape, a molten solid or some other form.

In accordance with the present invention, it has now been found that the forgoing objects and advantages may be readily obtained.

The adhesive joinder serves to retain the insert to the spoke bed. This restricts the insert from being dislodged from the spoke bed and additionally may serve to maintain lateral alignment between the rim opening and the insert opening. By retaining the insert to the spoke bed, the adhesive joinder provides for easy assembly of the spoke(s) to the rim without the insert becoming dislodged.

Also, the insert may be conformable to fill any recesses and or gaps or surface irregularities at the interface where the insert and spoke bed meet. This effectively serves to match the surface of the insert to the surface of the rim at this interface. This also results in a stable interface between the insert and rim, limiting any possible movement therebetween. By filling any mismatch or gaps, the adhesive interface provides a full surface area of interface, thus distributing the spoke tensile loads evenly across a greater area of interface, correspondingly reducing stresses in the rim. Further, by filling any mismatch or gaps, the adhesive interface conforms and accommodates surface inconsistencies without requiring an additional manufacturing operation to finish or smooth these mismatched surfaces.

Additionally, the adhesive joinder permits the utilization of an insert in cases where it would otherwise be difficult or impossible to utilize an insert. For example, if the insert were not adhesively joined or retained to the spoke bed, the otherwise free-floating insert would render the assembly of the spokes to the rim as exceedingly difficult or impossible.

Furthermore, the insert may now be utilized to provide optimal geometry to engage the spoke and support spoke loads. This is particularly advantageous in a case where the spoke bed cannot easily provide such optimized geometry. The adhesive interface may serve to optimize the interface between the insert and spoke bed, thereby enhancing the functionality of the insert.

Still further, the rim may be made more easily without requiring a perfectly smooth surface that is perfectly matched to the insert. This results in reduced manufacturing cost. For example, carbon fiber rims are commonly produced through a bladder-molding process where it is difficult to control the interior surface of the rim such that the outboard surface of the spoke bed may have bumps, recesses, or wrinkles after molding. The adhesive may be utilized to fill any gaps between the insert and rim due to these bumps, recesses, or wrinkles.

Yet further, the insert serves to distribute spoke loads over a broader area of the rim. This allows the rim to be made thinner and lighter since the insert serves to reinforce and thicken the rim only in the localized area of the spoke load. The result is a completed wheel assembly that is lighter and/or stronger.

Further still, by positioning the adhesive interface at the outboard surface of the spoke bed, the spoke tensile loads serve to drive and press the insert against the outboard surface, thus the tensile load effectively serves to augment and support the adhesive joinder, pressing the insert against the rim, rather than trying to pull these two elements apart. As a result, the adhesive interface does not require exceptionally high strength. This saves cost, since a lower performance adhesive may be utilized. Depending on the application, the insert may need only to provide a retaining feature, simply to hold the insert in place as a matter of convenience, rather than requiring a high performance structural connection.

Another advantage is that pressure sensitive adhesives may be utilized at the adhesive interface. These adhesives are exceptionally simple and fast to apply, do not require curing or hardening, and require little, if any, cleanup or finishing. This further reduces manufacturing cost.

Further features of the present invention will become apparent from considering the drawings and ensuing description.

### BRIEF DESCRIPTION OF THE DRAWINGS

The present invention will be more readily understandable from a consideration of the accompanying exemplificative drawings, wherein:

FIG. 1a is a perspective view schematically illustrating the general configuration of a vehicle wheel as applied to a bicycle wheel.

FIG. 1b is a cross-sectional view along 3-3 of the wheel of FIG. 1a.

FIG. 2a is a partial perspective exploded view of a wheel of prior art design, with the rim shown in cross-section along an axial plane.

FIG. 2b is an enlarged perspective detail of a portion of the rim of FIG. 2a, with the rim shown in cross-section along an axial plane.

FIG. 2c is a partial perspective view, with the rim in cross-section along an axial plane, showing the wheel of FIG. 2a with the spoke and nipple assembled to the rim.

FIG. 2d is a detail view of the wheel of FIG. 2a, with the rim shown in cross-section along an axial plane.

FIG. 2e is a cross-section detail view along 57 of FIG. 2d.

FIGS. 3a-b are partial perspective views, describing the sequential assembly steps involved in assembling a reinforcement insert to a rim, including an adhesive joinder therebetween.

FIG. 3a is a partial perspective exploded detail view of the rim of a first embodiment of the present invention, with the rim shown in cross-section along an axial plane, including a rim insert and adhesive.

FIG. 3b is a partial perspective detail view, with the rim shown in cross-section along an axial plane, showing the embodiment of FIG. 3a, with the insert next adhesively assembled and joined to the spoke bed of the rim.

FIG. 3c is a cross-section detail view, taken along 114-114, of the embodiment of FIG. 3a and showing a spoke and nipple as next assembled to the assembly of FIG. 3b.

FIGS. 4a-b are partial perspective views of a second embodiment of the present invention, describing the sequential assembly steps involved in assembling a reinforcement insert to a rim, including an adhesive joinder therebetween.

FIG. 4a is a partial perspective exploded detail view with the rim shown in cross-section along an axial plane, including a rim insert and adhesive film.

FIG. 4b is a partial perspective detail view, with the rim shown in cross-section along an axial plane, showing the embodiment of FIG. 4a, with the insert next adhesively assembled and joined to the spoke bed of the rim by the adhesive film.

FIGS. 5a-c describe the sequential assembly steps involved in assembling a rim insert to a rim, including an adhesive joinder therebetween.

FIG. 5a is an exploded detail view of a third embodiment of the present invention, with the rim and insert shown in cross-section along an axial plane. The outboard surface of the spoke bed has an irregular and configured surface.

FIG. 5b is a partial cross-section detail view of the embodiment of FIG. 5a, showing the insert as next adhesively joined to the outboard surface.

FIG. 5c is a partial cross-section detail view of the embodiment of FIG. 5a, showing the spoke hole as next drilled through both the insert and the spoke bed.

FIG. 6a is a cross-section detail view along an axial plane, of a fourth embodiment of the present invention, showing the insert as adhesively joined to the spoke bed, where the insert includes a collar that longitudinally overlaps the spoke hole and the insert is configured to provide a swivel connection with a spoke nipple.

FIG. 6b is an exploded cross-section detail view along an axial plane, of the embodiment of FIG. 6a, showing the spoke and spoke nipple as aligned prior to assembly with the insert and rim.

FIG. 6c is a cross-section detail view along an axial plane, of the embodiment of FIG. 6a, showing the spoke and spoke nipple as next assembled to the insert and rim, including a self-aligning swivel engagement between the insert and spoke nipple.

FIG. 6d is a cross-section detail view along an axial plane, of the embodiment of FIG. 6a and corresponding to the view of FIG. 6a, showing an alternate adhesive interface wherein the adhesive interface is between the outside of the collar and the sidewall the spoke hole.

FIG. 7a is a cross-section detail view taken along an axial plane, of a fifth embodiment of the present invention, showing the insert as adhesively joined to the spoke bed, where the insert is contoured to include a bearing surface and outboard edge that are skewed to be aligned with the tensile axis of the spoke.

FIG. 7b is a cross-section detail view taken along an axial plane, of the embodiment of FIG. 7a, showing the spoke and spoke nipple as next assembled to the insert and rim, where overlie engagement interface between the insert and spoke nipple is angled and aligned with the tensile axis of the spoke.

FIG. 8a is a cross-section detail view taken along an axial plane, of a sixth embodiment of the present invention, showing the insert as adhesively joined to the spoke bed during formation of the rim, also including mechanical retaining of the insert to the rim.

FIG. 8b is a cross-section detail view taken along an axial plane, of the embodiment of FIG. 8a, showing the insert as next internally threaded, with an externally threaded spoke aligned for subsequent threadable assembly thereto.

### DETAILED DESCRIPTION OF THE INVENTION

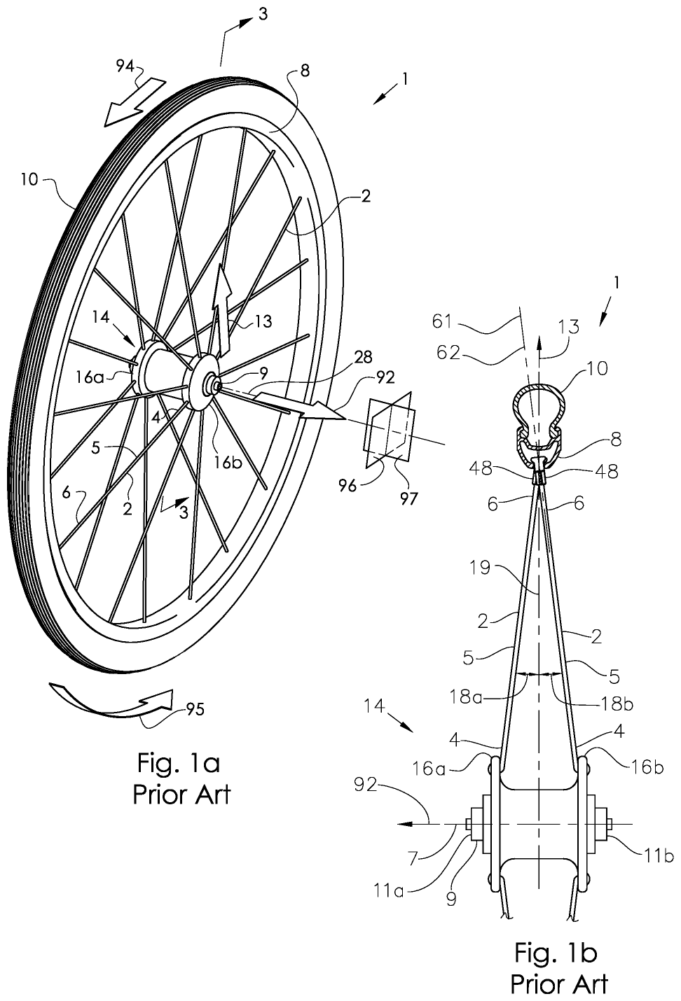

FIGS. 1a-b describe the basic configuration of an exemplary prior art vehicle wheel, in particular, a bicycle wheel 1, as well as a description of the direction conventions used throughout this disclosure. For clarity, the bicycle frame and the quick release skewer assembly are not shown in this figure. The hub shell 14 is rotatable about the axle 9 and includes at least two axially spaced hub flanges 16a and 16b, each of which include a means for connecting with a multiplicity of spokes 2 connected thereto. Axle 9 includes end faces 11a and 11b that define the spacing of its mounting with the frame (not shown). The axial axis 28 is the axial centerline of rotation of the bicycle wheel 1. The hub flanges 16a and 16b may be contiguous with the hub shell 14 or may be separately formed and assembled to the hub body 12 portion of the hub shell 14. Each spoke 2 is affixed to its respective hub flange 16a or 16b at its first end 4 and extend to attach the rim 8 at its second ends 6. The tire 10 is fitted to the outer periphery of the rim 8. The wheel 1 of FIG. 1 is generic and may be of tension-spoke or compression-spoke design.

The axial direction 92 is any direction parallel with the axial axis 28. The radial direction 93 is a direction generally perpendicular to the axial direction 92 and extending generally from the axial axis 28 radially outwardly toward the rim 8. The tangential direction 94 is a direction generally tangent to the rim at a given radius. The circumferential direction 95 is a cylindrical vector that wraps around the axial axis 28 at a given radius. A radial plane 96 is a plane perpendicular to the axial axis 28 that extends in a generally radial direction at a given axial intercept. An axial plane 97 is a plane that is generally parallel to the axial axis. An orientation that is radially inboard (or inward) is nearer to the axial axis 28 of rotation and a radially outboard (or outward) is further from the axial axis. An axially inboard (or inward) orientation is an orientation that is axially proximal to the axial midpoint between the two end faces 11a and 11b. Conversely, an axially outboard (or outward) orientation is an orientation that is axially distal to the axial midpoint between the two end faces 11a and 11b. A radially inboard orientation is an orientation that is radially proximal to the axial axis 28 and a radially outboard orientation is an orientation that is radially distal to the axial axis 28. An axially inwardly facing surface is a surface that faces toward the axial midpoint between the two end faces 11a and 11b. Conversely, an axially outwardly facing surface is a surface that faces away from the axial midpoint between the two end faces 11a and 11b. While it is most common for the hub shell 14 to rotate about a fixed axle 9, there are some cases where it is desirable to permit the axle 9 to be fixed with the wheel 1 such as the case where the wheel 1 is driven by the axle 9.

For the purposes of using conventional terminology, the term “hub flange” is used herein to describe a region of the hub shell 14 to which the spokes 2 are joined. While the surface of the hub flange may be raised and flange-like in comparison to other surfaces of the hub shell 14, this is not a requirement for the present invention and the hub flange 16 may alternatively be flush or recessed relative to other hub shell surfaces.

As is well known in the art, a wheel 1 may be of tension-spoke construction, where the central hub hangs in tension by the spokes from the rim portion directly above, or it may be of compression-spoke construction, where the hub is supported by compressing the spoke directly beneath it. The spoke is braced between its anchor points at the rim and hub. Since the present invention may be directed toward bicycle wheels and since the tension-spoke wheel is generally a more efficient structure than compression-spoke wheel, most of the discussion herein is focused with an eye toward tension-spoke wheel construction. However, it is anticipated that most, if not all, of the embodiments of the present invention may be adapted or otherwise applied to compression-spoke wheel construction as well. For a tension-spoke wheel, it is preferable that the wheel includes at least two hub flanges that are axially spaced on either side of the rim or, more specifically, the spoke attachment points at the rim. Thus the spokes fixed to opposite hub flanges will converge as they extend to the rim. Additionally, a tension-spoke wheel will usually be pre-tensioned during assembly to create a pre-tensioned structure of balanced spoke tension that allows the axle supporting loads to be distributed among several, if not all, of the spokes of the wheel. It is this ability to share the stresses among its spokes that helps to make the tension-spoke wheel the highly efficient structure that it is. For a compression-spoke wheel, it is often preferable to employ at least two axially spaced hub flanges, however, in the case where the spokes have sufficient bending stiffness to support the requisite lateral or side-to-side loads, only a single hub flange may be employed.

As shown in FIG. 1B, the radial axis 19 of the wheel 1 is a radial axis axially positioned midway between the flanges 16a and 16b. The spokes 2 connected to their respective flanges 16a and 16b commonly converge axially (by bracing angles 18a and 18b) to their connection point with the rim 8.

The spoke 2 is a generally long slender tensile element with a longitudinal axis 62 along its length and generally parallel to its sidewalls. The spoke 2 also has a tensile axis 61 of applied tensile load 58 that extends along the span portion 5 of the spoke 2 between its anchor points at the rim 8 and hub flange 16. The tensile axis 61 is generally collinear to the longitudinal axis 62, except where the spoke 2 is bent to deviate from the tensile axis 61. For the purposes of definition, as relating to spokes 2 and connections thereto, the term “longitudinal” herein refers to alignment along the longitudinal axis 62. A longitudinally inboard (or inward) orientation refers to an orientation proximal the midpoint of the span portion. Conversely, a longitudinally outboard (or outward) orientation refers to an orientation distal the midpoint of the span portion 5. The term “lateral” herein refers to an orientation in a direction generally perpendicular to the longitudinal axis 62. A laterally inboard (or inward) orientation refers to an orientation proximal the longitudinal axis. Conversely, a laterally outboard (or outward) orientation refers to an orientation distal the longitudinal axis 62.

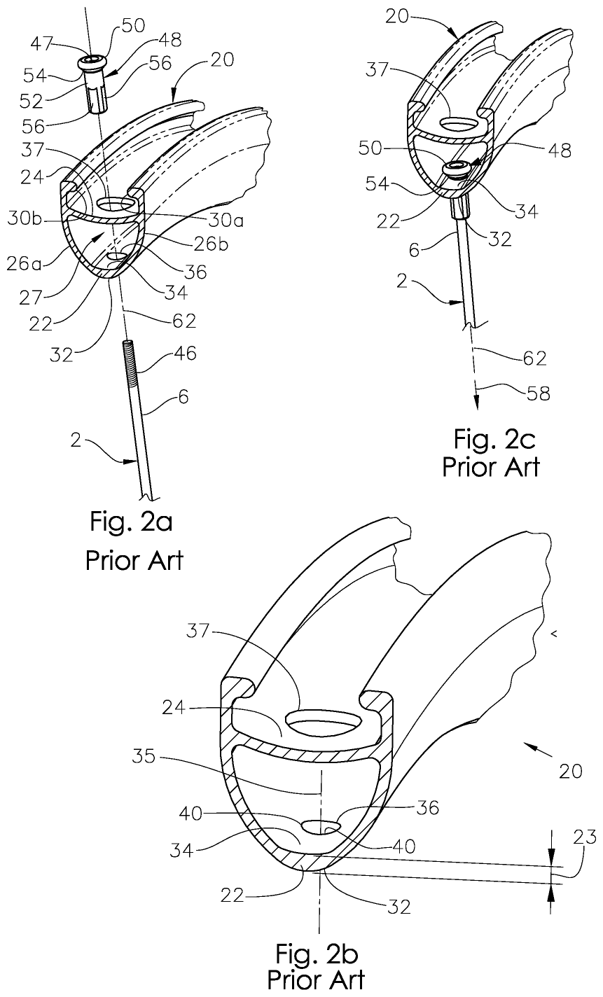

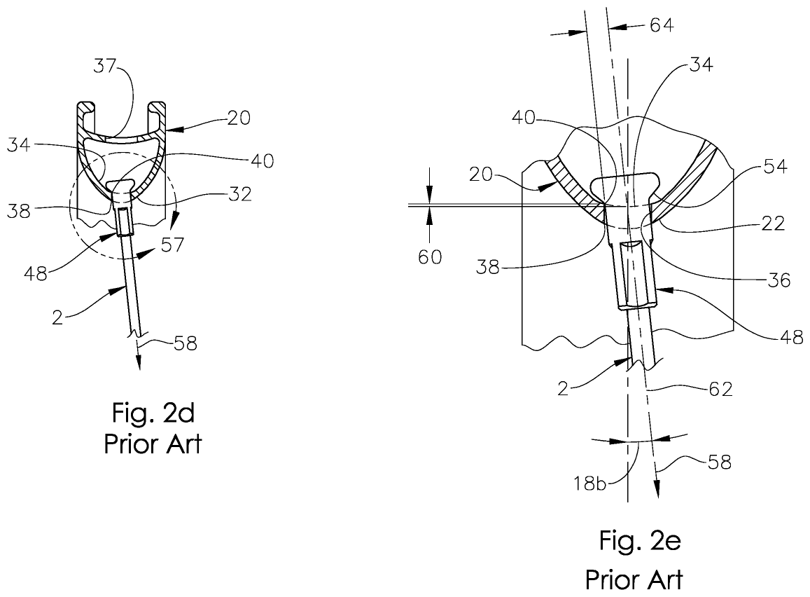

FIGS. 2a-e describe an exemplary rim 20 of generally conventional geometry. As detailed in FIGS. 2a and 2b, rim 20 is of a generally hollow construction, commonly termed “double-wall” construction, and includes a radially inboard spoke bed 22 wall of thickness 23 and a radially outboard tire bed 24 wall and generally radially extending sidewalls 26a and 26b to define a generally hollow circumferential cavity 27. Spoke bed 22 is a wall or web portion of the rim 20 that includes a radially inboard surface 32 and a radially outboard surface 34 and is defined herein as the portion of the rim to which the spoke is structurally connected and/or anchored. Hooked flanges 30a and 30b are adapted to engage the beads of a conventional tire (not shown).

The spoke bed 22 is pierced with a plurality of spoke holes 36 adapted for connection with their respective spokes 2 via spoke nipples 48. The term “nipple” and “spoke nipple” are used interchangeably herein. It may be seen that the spoke hole 36, which extends along hole axis 35, has a radially inboard entrance 38 at its intersection with the radially inboard surface 32 and a radially outboard entrance 40 at its intersection with the radially outboard surface 34. Spoke hole 36 is most commonly a circular cylindrical hole that is commonly produced by drilling along hole axis 35 or by other fabrication processes. The tire bed 24 wall is pierced by access hole 37 that is preferably aligned with spoke hole 36, to permit the nipple 48 to be assembled as shown in FIGS. 2a and 2c. Note that access hole 37 is merely one common means to permit the nipple 48 to be assembled to the rim; a wide range of alternative means may be substituted, including means that do not require a access hole.

It is useful to understand that it is common to manufacture the rim 20 by extruding the straight profile shown here and rolling the extrusion into a circumferential hoop with its ends joined by either a welded, sleeved or pinned connection. Spoke holes 36 and access holes 37 are then drilled in their proper locations. Another common rim manufacturing process includes bladder molding where an inflatable bladder is pressurized within the cavity 27.

FIG. 2a shows an exploded view that describes the conventional arrangement by which the second end 6 of the spoke 2 is connected to the rim 20. The second end 6 of spoke 2 includes external threads 46 to mate with internal threads 47 of spoke nipple 48. Spoke nipple 48 includes an enlarged head 50 and a shank 52, with a generally conical tapered transition portion 54 extending radially outwardly between the shank 52 and the underside of the head 50. Spoke nipple 48 also includes flats 56 for engagement with a mating wrench (not shown) for manual manipulation to adjust the spoke pre-tension by adjusting the threaded engagement between external threads 46 and internal threads 47. Nipple 48 is considered an “external” spoke nipple, since it has a shank 52 that extends through the spoke hole 36 so that its flats are exposed and may be manipulated externally to the rim 20. FIGS. 2c-f shows the spoke nipple 48 threadably assembled to the spoke 2 such that the transition portion 54 overlies and contacts the outboard entrance 40. The spoke nipple 48 is thereby structurally braced against the spoke bed 22, with transition surface 54 bearing against the outside edge 168 of spoke hole 36 and/or the outboard surface 34 to resist the spoke tension 58 of the spoke 2.

As shown in FIG. 2e, due to the bracing angle 18b of the spoke 2, the spoke nipple 48 may not be perfectly aligned with the outboard surface 34 and/or the outboard entrance 40. This results in very highly concentrated bearing stresses in the spoke bed 22 and nipple 48 due to tensile load 58. This high contact stress may result in localized galling as the nipple 48 is rotatably manipulated with in its spoke hole 36. Further, this high contact stress may cause excessive stress and deformation of the nipple 48 and/or spoke hole 36. This very high localized stress also commonly causes cracking and failure of the rim due to fatigue. To resist the stress and minimize such failure, the spoke bed 22 needs to be very thick (thickness 23), which adds weight to the rim, detracting from the performance of the wheel.

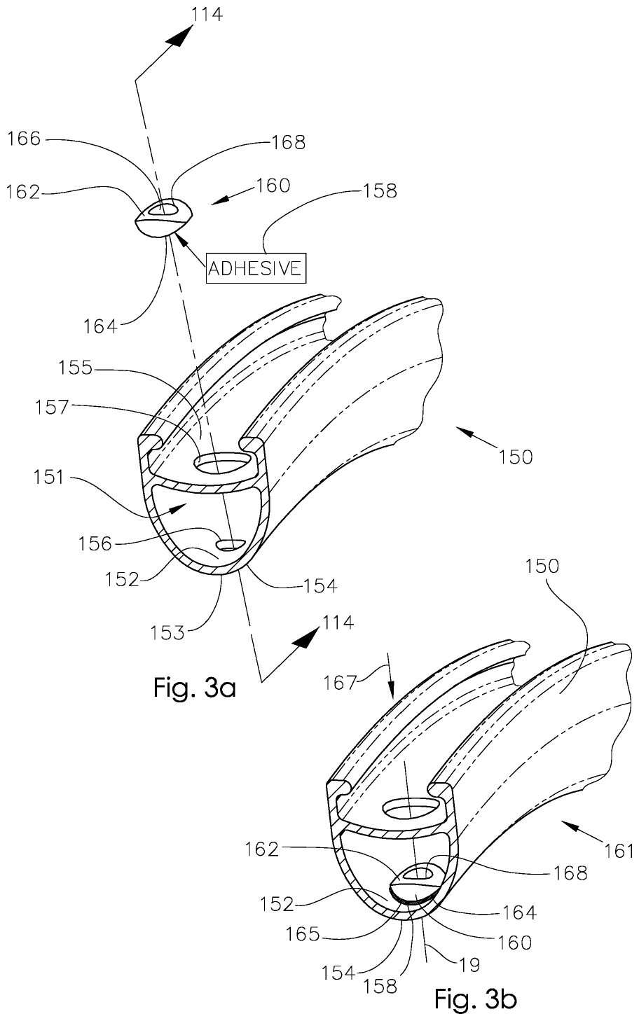

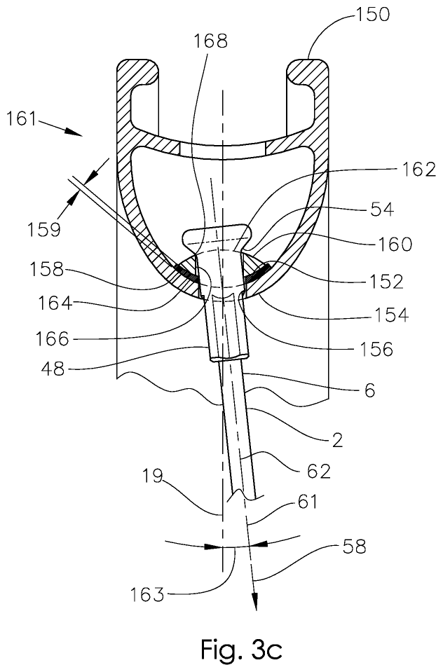

FIGS. 3a-c describes an embodiment wherein a pre-formed reinforcement insert is adhesively joined and affixed to the spoke bed of a rim. This arrangement is particularly beneficial when utilizing an insert to provide localized reinforcement and/or provide specific geometry to the spoke bed of the rim. By adhering the insert to the spoke bed, the insert will not become dislodged from the spoke bed during the assembly of the spoke to the rim. Furthermore, the adhesives utilized may be conformable materials such that the adhesive serves as a filler to match the surface of the insert to the outboard surface of the spoke bed at the laterally-overlying engagement interface between the two.

FIG. 3a shows the components in exploded view prior to their assembly. Rim 150 is of generally conventional configuration and includes a spoke bed 154 with an outboard surface 152 that has a concave profile and an inboard surface 153. Rim 150 includes a circumferential cavity 151 between the spoke bed 154 and tire bed 155. The spoke bed 154 is pierced with a plurality of spoke holes 156 extending therethrough between outboard surface 152 and inboard surface 153. Rim 150 also includes a tire bed 155 having an access hole 157 therethrough that is aligned with the spoke hole 156.

Included is insert 160 that serves to provide a localized convex outboard surface at the location surrounding the spoke 2. Insert 160 includes a convex outward surface 162 and a convex inward surface 164 and a nipple hole 166 extending through the insert 160 to provide passage for the shank 52 of the spoke nipple 48. The intersection with the outward surface 162 and the spoke hole 166 (i.e. entrance to the spoke hole 166) creates an outside edge 168. Inward surface 164 is a radially-inboard facing convex surface with a generally constant radius of curvature to provide a matched surface with the concave outboard surface 152 of the rim 150. Thus, the nested concave/convex surfaces provide that insert 160 may swivel with respect to the outboard surface 152 to create a self-aligning capability between the insert 160 and the rim 150. Spoke 2 and nipple 48 are of the conventional type and identical to those described in FIGS. 2a-e. Both the insert 160 and rim 150 are pre-formed elements as shown in FIG. 3a.

Prior to assembling the insert 160 to the spoke bed 152, an adhesive 158 (such as a 2-part epoxy paste adhesive, for example) is applied to the inward surface 164. The adhesive 158 is shown as representational, but it is understood that the adhesive may have any type of form that adhesives are known to have. The insert 160 is then assembled to the spoke bed 152 through the access hole 157 in direction 167 as shown in FIG. 3b such that inward surface 164 (with adhesive applied thereto) is brought to interface and abut against the outboard surface 152 ,with the adhesive 158 sandwiched therebetween in the conventional manner. It is noted that this assembly method is but one option, the adhesive 158 may alternatively or additionally be applied to the outboard surface 152. Further, the adhesive 158 and/or the insert 160 may alternatively be introduced through the spoke hole 156 or through the cavity 151 or by any other means.

Nipple hole 166 is aligned with spoke hole 156 such that the two holes overlap. Depending on the adhesive used, the adhesive 158 may be conformable to follow the contour of the inward surface 164 and outboard surface 152 at the adhesive interface 165. Once the adhesive is dried, cured, cooled, or is otherwise completed, the insert 160 becomes adhesively joined to the spoke bed 154 at the adhesive interface 165 therebetween. In the case of an epoxy paste adhesive, the adhesive is allowed to cure and harden to adhesively join the inward surface 164 of the insert 160 with the outboard surface 152 of the spoke bed 154. The epoxy adhesive has a softened state prior to curing that is a flowable, so it may flow to fill any voids, gaps, or inconsistencies between the inward surface 164 and outboard surface 152. Upon subsequent curing and hardening, these voids or gaps now are filled with hardened material, serving to create a perfectly matched rigid surface interface between the inward surface 164 and outboard surface 152. It is noted that the contour of inward surface 164 is arcuate as shown and closely matched to the mating arcuate outboard surface 152 while leaving sufficient space therebetween for bondline thickness 159 of the adhesive 158. This matching of contours, to the degree possible, is preferable to insure that any variation in bondline thickness 159 is minimized and that the optimum bondline thickness 159 is achieved. For optimal adhesive performance, it is most preferable that any variation in bondline thickness 159 is less than 0.4 millimeters at the adhesive interface 165. It is understood that, for visualization purposes in this and other embodiments herein, the bondline thickness 159 is shown as considerably thicker than may be commonly employed.

The adhesive 158 is positioned within the laterally overlying engagement interface between the inward surface 164 of the insert 160 and the outboard surface 152 of the spoke bed 154. Depending on the adhesive type and bondline thickness 159, the inward surface 164 may not have direct contact with the outboard surface 152, but instead the inward surface 164 contacts the adhesive 158 and the adhesive 158 contacts the outboard surface 152, as shown in FIG. 3c. An additional feature of the adhesive is that it may be utilized to create a galvanic barrier and/or galvanic sealing between the insert 160 and rim 150 to prevent or otherwise mitigate any galvanic corrosion therebetween.

Once the insert(s) 160 have been adhesively joined to the rim 150 at the adhesive interface 165, the insert 160 is retained to the rim 150 in the assembly 161 such that the insert 160 will not inadvertently be displaced and the proper alignment of the insert is maintained relative to the rim 150. Spoke hole 156 is preferably overlapping and aligned with nipple hole 166 to facilitate the subsequent assembly shown in FIG. 3c.

Next, the spoke 2 and nipple 48 may be assembled to the assembly 161 of FIG. 3b in the conventional manner, as shown in FIG. 3c, with an overhanging overlie engagement between the transition portion 54 and the outer edge 168 where the head 50 overhangs the outward surface 162. There is also an overlie engagement between the inboard surface 164 and the outboard surface 152 to support spoke tension load 58. As shown here, there is a single spoke 2 associated with a single insert 160. Since a complete wheel assembly includes several individual spokes 2, it is envisioned that a plurality of spokes 2 of the wheel may be connected and anchored to the rim 150 in a similar manner, with an individual insert 160 associated with each individual spoke 2. Nipple 48 may be considered as an intermediate connecting element, where the spoke 2 is connected to the nipple 48 by the threadable engagement therebetween and the nipple 48 is connected to the insert 160 by the overhanging overlie engagement therebetween.

As shown in FIGS. 3a-c, it may be seen that the intersection between the cylindrical nipple hole 166 and the outward surface 162, creates outer edge 168. Transition portion 54 of spoke nipple 48 contacts and bears against the outer edge 168 of the nipple hole 166. The spoke nipple 48 is thereby braced against the spoke bed 154 via the insert 160 to resist the spoke tensile load 58 of the spoke 2. The inward surface 164 bears longitudinally inwardly against the outboard surface 152 such that the tensile load 58 serves to augment the adhesive joinder and to press the inward surface 164 against the outboard surface 152, placing the adhesive 158 in compression, rather than in tension. As such, the tensile load 58 serves to augment the adhesive joinder, rather than resist it.

FIGS. 3a-b show the adhesive 158 as applied to the inward surface 164 for subsequent assembly to the outboard surface 152. The insert 160 may be fixtured to the rim 150 by a fixturing method known in industry for alignment therebetween and to maintain alignment while the adhesive cures, hardens, solidifies, or otherwise completes its cycle to provide the adhesive joinder. Alternatively, the spoke 2 and nipple 48 may be assembled to the rim 150 and insert 160 prior to curing, hardening, or completion of its adhesive cycle, such that the completion of the adhesive curing or hardening cycle occurs after the assembly shown in FIG. 3c. In any case, the result is the assembly 161 between the rim 150 and insert 160 by adhesive 158 as shown in FIGS. 3b-c.

The adhesive 158 may be utilized to create a structural connection between the insert 160 and rim 150 or it may be utilized to simply provide a non-structural retaining and/or alignment therebetween. Similarly, the adhesive 158 may be utilized to create a permanent joinder between the insert 160 and rim 150 or it may be utilized to provide a temporary connection therebetween such that the insert 160 may be subsequently disconnected from the rim 150. An “adhesive joinder” may include a structural connection, where the two adherends or substrates are structurally connected and secured to each other by adhesive at an adhesive interface, or it may be a non-structural retaining connection, where the two adherends are non-structurally retained to each other to maintain their relative position.

For the purposes of definition herein, the term “adhesive” refers to a material that, when applied to surfaces of materials, can retain and/or secure them together to resist their separation through the mechanism of adhesion or surface interaction. Some examples of adhesive include thermosetting adhesives (such as epoxy) that include a curing cycle, molten adhesives that are subsequently cooled and hardened (such as braze, solder, or thermoplastic), tacky adhesives that provide stickiness between surfaces (such as pressure sensitive tape, etc.), drying adhesives that cure through flashing or evaporation of a constituent (such as rubber cement, etc.), among others. Adhesives may be grouped into several types and classes, each may have its own unique advantage as known in industry. Adhesives are commonly considered to be nonmetallic, but for definition purposes herein, the term “adhesive” may also include metallic adhesives that attach through intermetallic bonding such as solder or braze. The adhesive joinder described herein is applicable to any of the types or classes, dependent on the requirements or convenience of a particular application. An adhesive joinder is in contrast to a mechanical connection, such as threaded fasteners, eyelets, rivets, snap engagements, etc.

The term “adhesive interface” herein generically describes the interface between the insert and the rim that includes the adhesive therebetween. As is commonly understood in industry, this adhesive interface actually includes two interfaces, the interface between the insert and the adhesive and the interface between the adhesive and the rim, with the adhesive itself shared in common between the two.

As shown in FIGS. 3a-c, there is a single insert 160 that interfaces with a single spoke 2 and/or portion thereof (i.e. nipple 48). As an alternative, it is envisioned that a single insert may interface with a plurality of spokes.

As shown in FIG. 3c, the spoke 2 and nipple 48 are assembled to the assembly 161 in the conventional manner. The transition surface 54 is bearing against the outside edge 168 to support spoke tensile load 58. Because outward surface 162 is arcuate, outside edge 168 is saddle shaped, which provides a rocker contour that permits the nipple 48 to rock and pivot as shown to provide self-aligning accommodation of the bracing angle 163 between longitudinal axis 62 and a radial axis 19. As such, the outward surface 162 and outer edge 168 are designed for optimal engagement with the nipple 48, which serves as a portion of the spoke 2, to permit the nipple 48 to be aligned with the longitudinal axis 62 and the span of the spoke 2.

To support tensile load 58, the inward surface 164 is bearing against the spoke bed 154 in a first bearing interface, while the transition surface 54 is bearing against outside edge 168 in a second bearing interface. The area of the first bearing interface is preferably greater than the area of the second bearing interface. Thus, the insert 160 serves to distribute the high stresses of the second bearing interface over the larger surface area of the first bearing interface, which correspondingly serves to reduce the corresponding bearing stress at the spoke bed 154. In this way, the insert 160 of this embodiment, as well as the inserts utilized in other embodiments herein, may serve to reduce stress and otherwise reinforce the mating spoke bed in a localized area surrounding the spoke. It may be preferable that the insert may have greater overall radial thickness and/or rigidity than the adjacent spoke bed, since this rigidity may serve to minimize any deformation of the insert and transmit the bearing loads though the adhesive interface most effectively. These features provide significant benefit by allowing the spoke bed to be thinner and lighter.

The bearing interface between insert 160 and spoke bed 154 preferably has a greater area than if the transition surface 54 were bearing directly against the spoke bed 154 and/or spoke hole 156. The insert 160 is shown to be thicker than spoke bed 154 and may have greater rigidity, thereby serving to minimize any deflection of insert. Thus, the insert 160 serves to distribute bearing loads over a larger area of the spoke bed 154, thus reducing bearing stress in the rim 150. Further, the insert 160 is shown here to provide optimized bearing interface (i.e. rocker contour) with the nipple 48.

The geometry of the spoke bed 154, outboard surface 152 and insert 160 are shown here as providing exemplary geometries and interface therebetween, including interface with the spoke nipple 48. A wide range of alternate geometries and interfaces may be substituted herein. Further, the present invention may be adapted to “internal nipples” where the spoke nipple is completely concealed by the exposed surface of the rim. Still further, the present invention may alternatively be adapted to “single wall” rims, where the spoke bed and tire bed are combined as a single common wall, without a cavity 151 therebetween.

It is noted that spoke tensile load 58 serves to press inward surface 164 against outboard surface 152 to generally compress the adhesive 158. Thus, the tensile load 58 generally serves to mechanically augment the adhesive joinder between the insert 160 and rim 150, with little or any tensile load therebetween. This means that the present invention is adaptable to an arrangement whereby the adhesive joinder of the present invention may be utilized in circumstances where a structural joinder is not necessary and only a retaining (i.e. positional) joinder will suffice. This is in contrast to U.S. Pat. No. 7,090,307, where spoke tensile load serves to apply tensile load to the “reinforcement member” that is joined to the rim, thus serving to pull the “reinforcement member” away from the rim. As such, any joinder therebetween must be able to support the entire spoke tensile load 58.

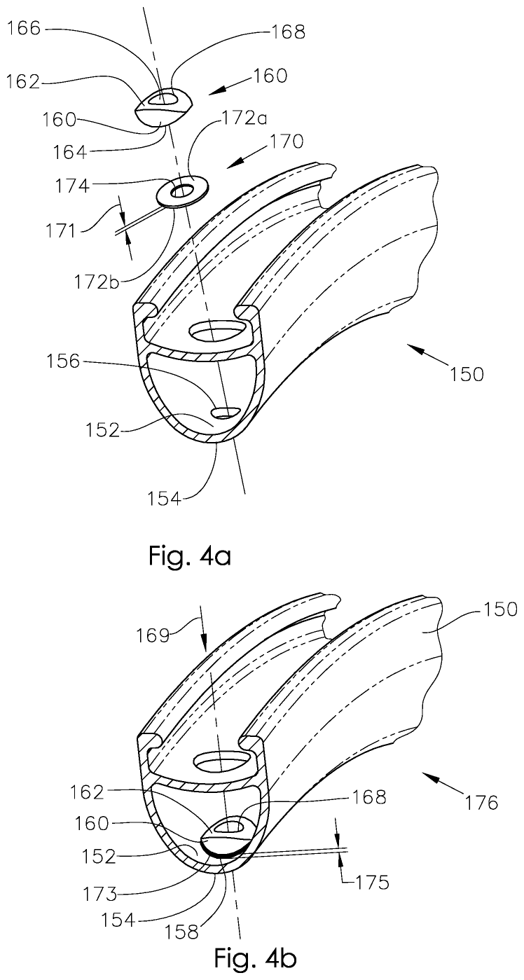

The embodiment of FIGS. 4a-b is identical to that of FIGS. 3a-c with the exception that a double-sided tape or adhesive film is substituted for the adhesive 158 of FIGS. 3a-c. Rim 150 and insert 160 are identical to those described in FIGS. 3a-c. Adhesive washer 170 includes an outboard surface 172a and inboard surface 172b, with thickness 171 therebetween, and hole 174 therethrough.

Adhesive washer 170 may be stamped out of a double-sided tape material having adhesive on both the outboard surface 172a and inboard surface 172b. This type of adhesive may have a carrier layer between the two adhesive layers or it may just include adhesive without a carrier. This adhesive may simply be a pressure-sensitive adhesive (commonly termed “PSA”) that joins the adherends (i.e. inward surface 164 and outward surface 152) through its own tackiness and without any external activation, hardening, or curing to provide the adhesive joinder. Alternatively, the tape may be a structural adhesive tape, such as an epoxy film adhesive, that requires curing and/or activation in order provide the adhesive joinder. PSA may be especially advantageous in this application, since it may not require curing or hardening and may be quickly and easily applied, commonly with little or no cleanup of excess required.

The adhesive washer 170 may preferably include pressure-sensitive adhesive (“PSA”) because this type of adhesive is particularly easy to apply and may not require subsequent curing or hardening, thus reducing manufacturing time. An example of such an adhesive is commonly termed “double-sided tape”. The PSA commonly includes a carrier, but may otherwise be unsupported. This type of adhesive is commonly self-supporting such that it will not drip or sag during application, as such its form may be controlled such that it does not require clean-up of excess adhesive during manufacturing—further saving manufacturing time. The insert 160 may simply be pressed against the outboard surface 152 with the adhesive washer 170 therebetween, such that the tack of the PSA serves to affix the insert 160 to the rim 150. This assembly utilizes the adhesive washer 170 to retain and/or secure the insert 160 to the spoke bed 154 at an adhesive interface 173. The adhesive interface 173 is actually made up of two interfaces: a first adhesive interface between the inward surface 164 and outboard surface 172a; and a second adhesive interface between the inboard surface 172b and outboard surface 154. As an alternative to PSA, the washer 170 may be a curable film adhesive that is commonly provided in sheet form that may be cut in any desired profile. The film adhesive may include a carrier or may be unsupported.

FIG. 4a corresponds to FIG. 3a and shows the rim 150, insert 160, and adhesive washer 170 in exploded view prior to their assembly. FIG. 4b corresponds to FIG. 3b and shows the insert 160 as adhered to the rim 150 by adhesive washer 170 to create assembly 176.

The adhesive washer 170 is positioned within the laterally overlying engagement interface between the inward surface 164 of the insert 160 and the outboard surface 152 of the spoke bed 154. Depending on the adhesive type and bondline thickness 175, the inward surface 164 may not have direct contact with the outboard surface 152, but instead the inward surface 164 contacts and is adhered to the adhesive washer 170 at a first adhesive interface and the adhesive washer 170 contacts and is adhered to the outboard surface 152 at a second adhesive interface. The bondline 175 thickness may correspond to washer thickness 171. The adhesive washer 170 is thus sandwiched between the insert 160 and the rim 150. Inward surface 164 is now adhered to outboard surface 172a and inboard surface 172b is now adhered to outboard surface 152 to create the adhesive joinder between insert 160 and rim 150 shown in FIG. 4b and to create assembly 176.

Once the insert(s) 160 have been adhesively joined to the rim 150 by respective adhesive washer(s) 170, the spoke (not shown) and nipple (not shown) may be assembled thereto in the conventional manner, as shown in FIG. 3c, with an overlie engagement between the transition portion 54 and the outward surface 162 or outer edge 168 and an overlie engagement between the inward surface 164 and the outboard surface 152 to support spoke tensile load 58.

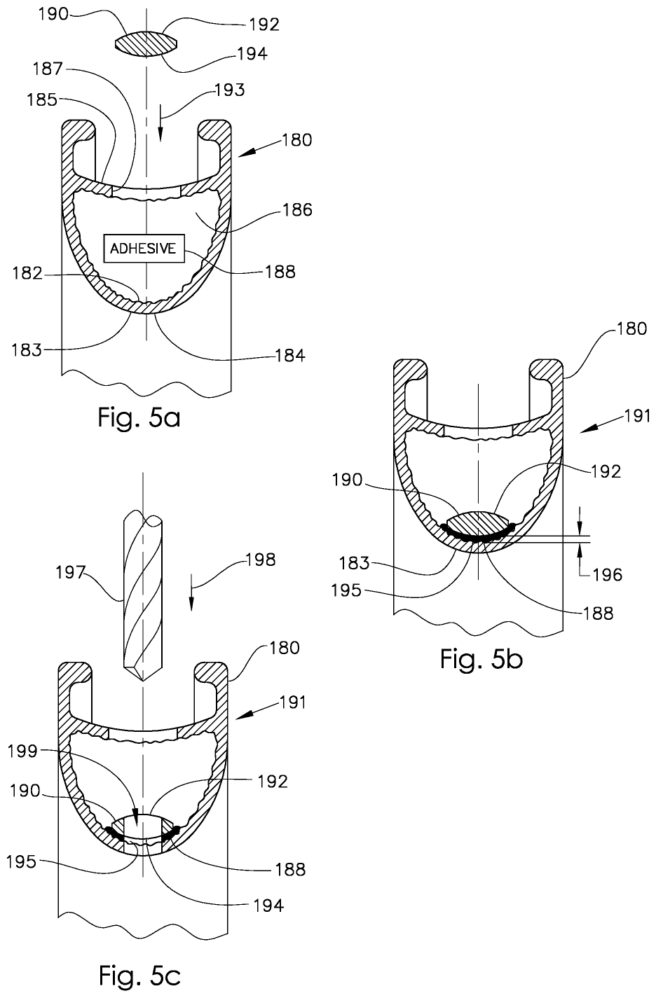

FIGS. 5a-c describe an embodiment similar to the embodiment of FIGS. 3a-c, however the insert and spoke bed do not include a hole therethrough, such that the hole is drilled or otherwise formed after the adhesive joinder therebetween.

As shown in FIG. 5a, rim 180 is generally identical to rim 150 except that it does not include spoke holes 156. Rim 180 is of generally conventional configuration and includes a spoke bed 184 with an outboard surface 182 and an inboard surface 183, a tire bed 185 with access hole 187 therein, and a cavity 186 therebetween. The cavity 186 is shown to have an uneven and configured surface, which may be representative of the uneven surface sometimes left by the bladder utilized in bladder molding of composite cycle rims, a common manufacturing process. Thus it may be seen that outboard surface 182 is also an uneven surface having multiple raised peaks with recesses therebetween.

Included is insert 190 that is identical to insert 160 except that it does not include nipple hole 166. Insert 190 includes a convex outward surface 192 and a convex inward surface 194. Inward surface 194 is a radially-inboard facing convex surface with a generally constant radius of curvature to provide a matched surface with the concave outboard surface 182 of the rim 180.

Prior to assembling the insert 190 to the spoke bed 192, an adhesive 188 (such as a 2-part epoxy paste adhesive, for example) is applied, in its softened state, to the inward surface 194 and or outboard surface 182. The insert 190 is then assembled in direction 193 to the spoke bed 182 as shown in FIG. 5b such that inward surface 194 is brought to interface and press against the outboard surface 182 with adhesive 188 therebetween. Once the adhesive 188 is subsequently dried, cured, cooled, or otherwise activated or completed, the insert 190 is now adhesively joined and affixed to the spoke bed 184 at the adhesive interface 195 therebetween. In the case of an epoxy paste adhesive, the adhesive is allowed to cure and harden to create an adhesive joinder between the inward surface 194 of the insert 190 with the outboard surface 182 of the spoke bed 184. It is noted that adhesive 188 is preferably flowable in its softened state and serves as a gap-filler to fill the aforementioned recesses of the outboard surface 182 at the adhesive interface 195. Once cured and hardened, these recesses or gaps now are filled with hardened adhesive material, serving to create a matched surface interface between the inward surface 194 and outboard surface 182. The result is a solid adhesive interface 195 with any voids, recesses, or gaps between the outboard surface 182 and the inward surface 194. As such, in addition to an adhesive joinder that the adhesive interface 195 additionally serves to provide a solidly filled and supported bearing interface between the insert 190 and outboard surface 182. The insert 190 is now solidly joined and stable relative to spoke bed 184 to which it is joined.

As shown in FIG. 5b, the insert 190 is now joined to the rim 180 at adhesive interface 195 between inward surface 194 and outboard surface 182. Adhesive 188 is used to adhesively bond and to connect or retain the inward surface 194 to the outboard surface 182 to create the adhesively joined assembly 191 in a manner similar to that described in FIGS. 3a-c. Due to the conforming of the adhesive 188 to the uneven outboard surface 182, the bondline thickness 196 is shown to be variable. The adhesive 188 is allowed to harden, cure, or otherwise complete, to create an adhesive joinder between insert 190 and rim 180.

Next, as shown in FIG. 5c, both the spoke bed 184, the adhesive 188, and the insert 190 are drilled through by drill 197 in direction 198 to create an aligned common spoke hole 199 therethrough. A spoke (not shown) and nipple (not shown) may now be assembled to assembly 191 in the manner described in FIG. 3c.

Once the insert(s) 190 have been affixed and adhesively joined to the rim 180 at the adhesive interface 195, the insert 190 is retained to the rim 180 such that the insert 190 will not inadvertently be displaced and the proper alignment of the spoke hole 186 is maintained relative to the rim 150 to facilitate the subsequent assembly with the spoke 2 and nipple 48 in a manner identical to that shown in FIG. 3c.

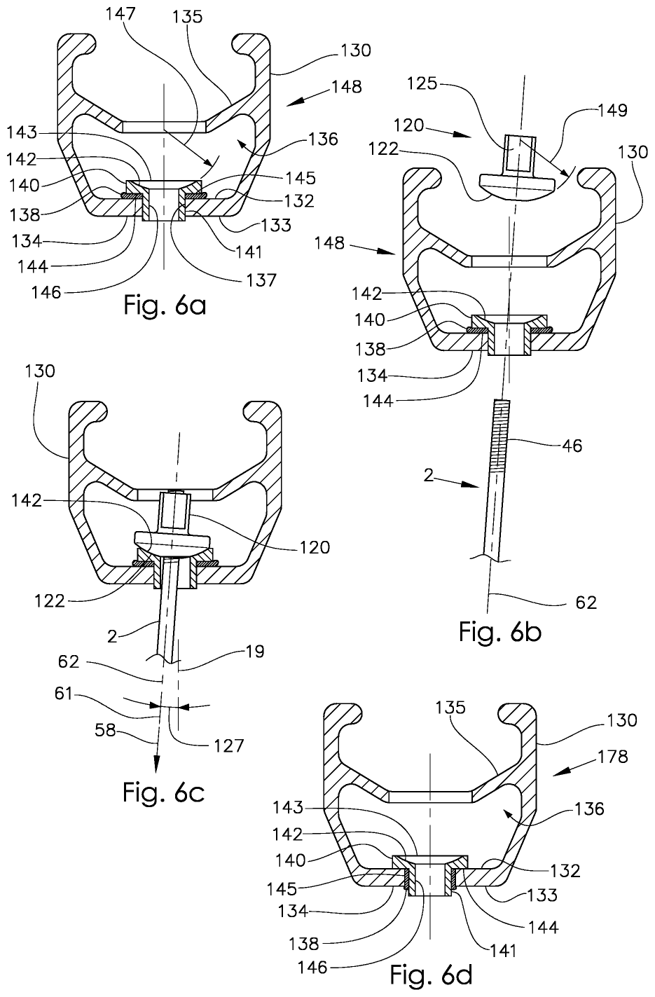

FIGS. 6a-c describe an embodiment similar to the embodiment of FIGS. 3a-c, however the insert 140 includes a spherical recess 142 of radius 147 to mate with the spoke nipple in a swivel arrangement. Insert 140 also includes a collar 141 that longitudinally overlaps the spoke hole 137. The nipple 120 is shown here as an “internal” nipple that is concealed by the rim 130 and does not extend radially inwardly of the spoke bed 134.

As shown in FIG. 6a, rim 130 is generally identical to rim 150, however the outboard surface 132 is generally flat in the axial direction. Rim 130 is of generally conventional configuration and includes a spoke bed 134 with an outboard surface 132 and an inboard surface 133, a tire bed 135, and a cavity 136 therebetween. Spoke bed 134 includes spoke hole 137 therethrough.

Insert 140 includes: an outward surface 143 with a spherical recess 142 to mate with the spherical surface 122 of nipple 120; a radially-inwardly facing bearing face 144 to bear against the outboard surface 132; a collar 141 extending radially inwardly from bearing face 144; and an opening 146 extending through the collar 141 and the remainder of insert 140.

FIG. 6a shows the insert 140 as adhesively joined to the spoke bed 134, with adhesive 138 providing an adhesive interface 145 between the bearing face 144 and the outboard surface 132 to create an adhesively connected assembly 148 in a manner similar to that described in previous embodiments herein. Collar 141 and opening 146 extend longitudinally inwardly from the outboard surface 132 within spoke hole 137 to longitudinally overlap the spoke bed 134.

FIG. 6b shows the nipple 120 and spoke 2 as aligned for assembly with the assembly 148 described in FIG. 6a. Nipple 120 is considered an “internal” or “hidden” nipple as described hereinabove and as known in industry. Nipple 120 includes internal threads (not shown) to threadably mate with the external threads 46 of spoke 2 in the conventional manner, and flats 125 to facilitate manual manipulation with a mating wrench. Nipple 120 includes a bearing surface 122 that has a convex spherical contour of radius 149 that is matched to radius 147 and is shown in FIG. 6c to nest and mate with the concave spherical recess 142 to permit the nipple 120 to swivel with respect to the insert 140 and rim 130.

Next, as shown in FIG. 6c, the spoke 2 and nipple 120 are assembled to the assembly of FIG. 6a, with the internal threads (not shown) threadably assembled to external threads 46. Nipple 120 may swivel in a ball-and-socket arrangement between bearing surface 122 and recess 142, which permits the spoke to be self-aligned to accommodate a bracing angle 127 (between longitudinal axis 62 and radial axis 19) or other desirable spoke 2 alignment.

The bearing surface 122 is bearing against spherical recess 142 in a surface-to-surface overlie engagement therebetween. The insert 140 is also matched and bearing against the spoke bed 134 to support tensile load 58. The bearing interface between insert 140 and spoke bed 134 preferably has a greater area than if the spoke bearing surface 122 were bearing directly against the spoke bed 134. The insert 140 may also have greater rigidity than spoke bed 154. Thus, the insert 140 serves to distribute bearing loads over a larger area of the spoke bed 134, thus reducing bearing stress in the rim 130. Further, the insert 140 is shown here to provide matched and optimized bearing interface (i.e. swivel) with the nipple 120.

FIG. 6d describes a variation on the embodiment of FIGS. 6a-c, where the adhesive interface 145 is not between the bearing face 144 and the outboard surface 132, but is instead between the outside diameter of the collar 141 and the sidewalls of the spoke hole 137. Rim 130 and insert 140 are identical to those described in FIGS. 6a-c. Adhesive 138 is positioned between the outside diameter of the collar 141and the sidewalls of the spoke hole 137 to provide an adhesive interface 145 therebetween and to create an adhesively connected assembly 178 in a manner similar to that described in previous embodiments herein. FIG. 6d provides an example where the insert 140 has an adhesive interface 145 with the spoke hole 137. As a further variation on the embodiment of FIGS. 6a-c, the adhesive may be positioned both between the outside diameter of the collar 141and the sidewalls of the spoke hole 137 and between the bearing face 144 and the outboard surface 132. This would result in an even greater adhesive interface between insert 140 and rim 130.

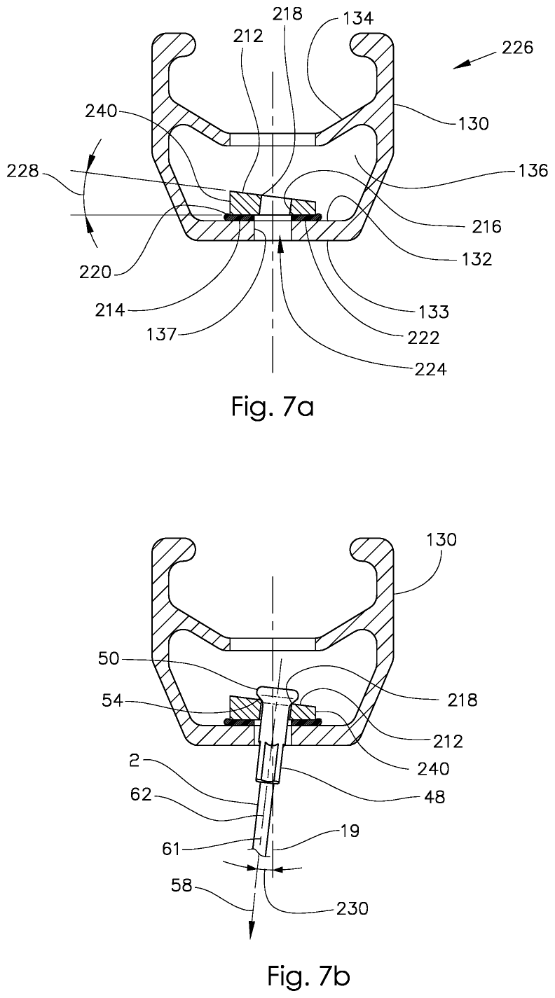

FIGS. 7a-b describe an embodiment similar to the embodiment of FIGS. 6a-c, except that insert 210 is substituted for insert 140. Rim 130 is identical to that described in FIGS. 6a-c. Insert 210 includes a radially outward surface 212, a bearing surface 214, and an opening 216 therethrough. Opening 216 has a radially outward entrance having a perimeter edge 218 at its intersection with outward surface 212. Insert 240 is shown to be wedge shaped and asymmetrical about the radial axis 19, with angle 228 between outward surface 212 and bearing surface 214 such that, upon joinder with the rim 130, the bearing surface 214 and perimeter edge 218 are tilted by angle 228 to be skewed and non-orthogonal relative to the radial axis 19 as shown.

FIG. 7a shows the insert 210 as adhesively joined to the spoke bed 134 by using adhesive 220 to create an adhesive joinder at adhesive interface 222 between the bearing surface 214 and the outboard surface 132 to create an adhesively connected assembly 226 in a manner described in previous embodiments herein. Opening 216 is laterally overlapping spoke hole 137 to create aperture 224 therethrough to receive the nipple 148 as shown in FIG. 7b. The nipple 148 and spoke 2 are identical to those described in FIG. 3c.

FIG. 7b shows the spoke nipple 48 and spoke 2 as assembled to the assembly 226 described in FIG. 7a. Angle 228 serves to skew and align the outward surface 212 and perimeter edge 218 to be asymmetric about the radial axis 19 as shown in FIG. 7a. The spoke 2 and nipple 48 are assembled and connected to the assembly 226 in a manner previously described herein. The transition surface 54 is bearing against edge 218 in an overhanging overlie engagement where the head 50 overhangs and overlies the outward surface 212. The insert 240 is also bearing against the spoke bed 134 to support tensile load 58. It is preferred that the angle 228 serves to skew outward surface 212 and perimeter edge 218 to be generally (i.e. within 3 degrees) orthogonal to the longitudinal axis 62. As such, the perimeter edge 218 is aligned with the transition surface 54 to maximize contact at the bearing interface therebetween and to accommodate bracing angle 230 as shown.

The bearing interface between insert 240 and spoke bed 134 preferably has a greater area than if the spoke nipple 48 were bearing directly against the spoke bed 134 and also greater area than the bearing interface between transition surface 54 and perimeter edge 218. Thus, the insert 240 serves to distribute bearing loads over a larger area of the spoke bed 134, thus reducing bearing stress at the rim 130. Further, the insert 240 is shown here to provide optimized bearing interface (i.e. angle 228) with the nipple 48.

The embodiments shown hereinabove describe an adhesive joinder between a pre-formed insert and a pre-formed rim. As an alternative, it is envisioned that the insert may be adhesively joined during the molding and/or forming of the rim itself. For example, and as is well known in industry for the molding of composite rims, the rim is molded from a “layup” of “prepreg” sheets. These prepreg sheets contain the requisite reinforcement fiber in combination with uncured resin, such as epoxy resin. The resin of the layup is then cured within a mold to create a fully-formed rim. The insert (s) of the present invention may be incorporated within the layup prior to molding such that the resin will adhesively join the insert to the rim during the molding process. Upon completion of the molding cycle and hardening of the resin, the insert is adhesively joined to the fully-formed rim. Such an arrangement is commonly termed “insert molding”.

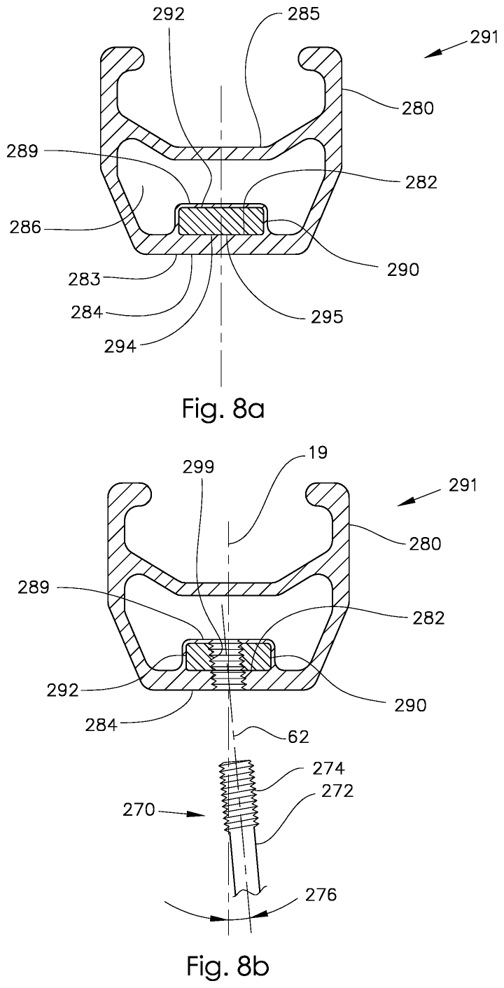

An example of such a molded composite rim and insert-molded insert is described in FIGS. 8a-b. As shown in FIG. 8a, rim 280 is schematically identical to rim 150 except that it does not include spoke holes 156. Rim 280 is molded from a “layup” of uncured “prepreg” sheets that includes the insert 290. The layup is then cured and hardened within a mold to create the fully-formed rim 280 that now includes the insert 290. The epoxy resin within the prepreg is then cured against the insert 290 in a conventional bladder molding process. The resin, such as epoxy, also has excellent adhesive properties, resulting in an adhesive joinder between the external surfaces of the insert 290 and the rim 280 at adhesive interface 295 therebetween. The fully cured rim 280 is of generally conventional configuration and includes a spoke bed 284 with an outboard surface 282 and an inboard surface 283, a tire bed 285, and a cavity 286 therebetween. Simultaneously, assembly 291 is created to include both the rim 280 and insert 290. In contrast to the previously described embodiments, FIG. 8a describes the adhesive joinder being created during the forming of the rim 280 as opposed to after the forming of the rim.

Insert 290 is similar to insert 190 and does not include a nipple hole. Insert 290 includes an outward surface 292 and an inward surface 294. Inward surface 294 is matched to the adjoining outboard surface 282. As shown, an overwrap portion 289 of the composite material of the rim 280 surrounds the insert 290 and wraps over the outward surface 292. As such, the overwrap portion 289 serves to mechanically capture and/or retain the insert 290, thus augmenting the adhesive interface 295 in joining and retaining the insert 290 to the rim 280. Alternatively, this overwrap portion 289 may be omitted and the joinder between spoke bed 284 and insert 290 is limited to the adhesive interface 295.

As shown in FIG. 8b, the spoke bed 284, insert 290, and overwrap portion 289 have been drilled and tapped therethrough to include an internally threaded spoke hole 299. It is preferable that insert 290 be made of aluminum, since it is a lightweight metal that may be easily tapped to form strong threads. Spoke hole 299 is aligned at bracing angle 276. Spoke 270 includes first end 272 and external threads 274. Spoke 270 may next be joined to assembly 291 by a threadable engagement between external threads 274 and the internal threads of spoke hole 299 such that spoke 270 is solidly anchored to the insert 290 and to the spoke bed 284 to support spoke tensile load 58. The composite material commonly is softer and does not provide high-strength threads, so the aluminum insert 290 may be the primary means of thread support. In contrast to the overhanging overlie engagement between the spoke nipple 48 and insert 160 described in FIG. 3c, the spoke 274 has a threaded engagement with the spoke hole 299 portion of the insert 290. This threaded engagement may not overhang the outward surface 292.

While my above description contains many specificities, these should not be construed as limitations on the scope of the invention, but rather as exemplifications of embodiments thereof. For example:

The embodiments shown herein describe a single insert that interfaces and is associated with a single spoke 2 and/or portion thereof (i.e. nipple 48). This is often preferable , as this allows the insert to be optimally positioned to align with the span of its associated spoke. Further, this allows that the weight of the insert may be minimized in comparison with an insert that extends to bridge between two or more spokes. However, as an alternative, it is envisioned that the insert may be configured to interface with a plurality of spokes.

The embodiments shown here describe an adhesive joinder directly between an insert and a rim and a direct engagement between the insert and the associated spoke (or nipple). It is envisioned that this assembly may include additional intermediate connecting elements between the spoke and the insert such that the spoke is engaged to the intermediate connecting element and the intermediate connecting element is engaged to the spoke.

The embodiment described herein describe the insert as having an opening or hole therethrough that surrounds the spoke about the longitudinal axis. As an alternative arrangement, it is envisioned that the opening of the insert only partially surrounds the spoke about the longitudinal axis. For example, the insert may include a U-shaped notch therein, where the notch is open at the lateral perimeter of the insert. The spoke may be engaged to the notch in much the same manner as described in the embodiments herein.

The inserts described herein may be configured to provide alignment of the spoke or nipple to accommodate a bracing angle. Bicycle wheel spokes are commonly laced in a “crossed” configuration where the spokes cross each other to also have circumferentially skewed angle as viewed in the plan view. It is preferable that the insert be configured to also accommodate this circumferentially skewed angle as well.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

What is claimed is:

1. A rim for a vehicle wheel, comprising:
a spoke bed wall having: a radially outboard surface; a radially inboard surface; and a spoke hole extending therethrough between said outboard surface and said inboard surface and configured to receive a spoke of the vehicle wheel;
a pre-formed insert having: a radially outward surface; a radially inward surface; and an insert opening extending therethrough between said outward surface and said inward surface and configured to receive said spoke;
an adhesive to provide an adhesive joinder at an adhesive interface between said insert and said outboard surface;
wherein said insert opening has a radially outboard first entrance having a first perimeter edge;
wherein said insert opening laterally overlaps said spoke hole;
wherein at least one of said first perimeter edge, said outward surface, and said insert opening is configured to provide a bearing surface to brace said spoke.

2. The rim according to claim 1, wherein said adhesive interface is configured such that spoke tension force of said spoke serves to compress said adhesive at said adhesive interface.

3. The rim according to claim 1, wherein said bearing surface of said insert includes said first perimeter edge, and wherein said spoke has a laterally overhanging overlie engagement interface between a bearing surface of said spoke and said first perimeter edge.

4. The rim according to claim 1, wherein said bearing surface of said insert includes said first outward surface, and wherein said spoke has a laterally overhanging overlie engagement interface between a bearing surface of said spoke and said outward surface.

5. The rim according to claim 1, wherein said spoke has a laterally overhanging overlie engagement interface between a bearing surface of said spoke and said insert that serves as a self-aligning engagement interface, wherein said self-aligning engagement interface is at least one of a swiveling engagement interface and a rocking engagement interface.

6. The rim according to claim 1, wherein said spoke has threadable engagement interface with said insert.

7. The rim according to claim 1, wherein said insert is configured to brace a singular spoke.

8. The rim according to claim 1, wherein: said inward surface has an inward surface contour; said outboard surface has an outboard surface contour; said adhesive joinder includes a bondline thickness; said inward surface contour is generally matched to said outboard surface contour including said bondline thickness therebetween.

9. The rim according to claim 1, including a mechanical retaining engagement between said insert and said rim.

10. The rim according to claim 1, including a first bearing interface between said inward surface and said outboard surface and a second bearing interface between said spoke and said insert, wherein the area of said first bearing interface is greater than the area of said second bearing interface.

11. The rim according to claim 1, wherein said adhesive has a flowable and softened state and a hardened state having greater hardness than said softened state; wherein said softened state corresponds to the application of said adhesive at said adhesive interface and said hardened state corresponds to said adhesive joinder.

12. The rim according to claim 1, wherein said adhesive is a film adhesive.

13. The rim according to claim 1, wherein said adhesive is a pressure sensitive adhesive.

14. The rim according to claim 1, wherein said adhesive is a themosetting adhesive

15. The rim according to claim 1, wherein said adhesive joinder is a non-structural joinder that serves to retain said insert to said spoke bed.

16. The rim according to claim 1, wherein said adhesive joinder is a structural joinder that serves to permanently connect said insert to said spoke bed.

17. The rim according to claim 1, including a bondline thickness at said adhesive interface, wherein said bondline thickness is variable.

18. The rim according to claim Error! Reference source not found., wherein said pre-formed insert includes said insert opening irrespective of said adhesive joinder.

19. The rim according to claim 1, wherein said rim is a preformed element and said adhesive joinder is between said pre-formed rim and said insert.

20. The rim according to claim 1, wherein said rim is formed against said insert with said adhesive joinder therebetween.

21. The rim according to claim 1, wherein said rim includes a radial axis and said spoke includes a longitudinal axis, wherein and said bearing surface is skewed to be asymmetrical about said radial axis.

22. The rim according to claim 21, wherein and said bearing surface is aligned to be generally orthogonal to said longitudinal axis.

23. The rim according to claim 1, wherein said insert has greater rigidity than spoke bed at said adhesive interface.
